(19) United States
(12) Patent Application Publication
(10) Pub. No.: US 2004/0010447 A1
(43) Pub. Date: Jan. 15, 2004

(54) System, method and apparatus for membership retention and conversion

(76) Inventor: Takao Asayama, Mountain View, CA (US)

Correspondence Address: Anna M. Vradenburgh, Brull Piccionelli Sarno Braun & Vradenburgh, Suite 2350, 1925 Century Park East, Los Angeles, CA, 90067, US

(21) Appl. No.: 10/438,760

(22) Filed: May 14, 2003

Related U.S. Application Data
(60) Provisional application No. 60/380,901, filed on May 15, 2002.

(51) Int. Cl. G06F 17/60

(52) U.S. Cl. 705/14

(57) ABSTRACT

Embodiments of the invention are directed to retention and conversion system for retaining existing members of a membership based program and encouraging new members to join the membership based program. In preferred embodiments, the system comprises an incentive program having an identifiable reward and an opportunity schedule, wherein the opportunity schedule sets forth the relationship between the membership type and extent of the opportunity to obtain the identified incentive Once a winning entry is selected, the identification of the winner is displayed in a restricted environment, wherein the winner must enter the restricted environment within a preset period of time to claim the incentive.

### RELATED APPLICATION

This application claims priority from provisional patent application entitled, A System, Method And Apparatus For Membership Retention and Conversion, Ser. No. 60,380,901 to Takao Asayama, filed on May 15, 2002, which is fully incorporated herein by reference.

### FIELD OF THE INVENTION

This invention is directed to a system, method and apparatus for increasing the retention and conversion rates for membership in a program offering goods or services. In particular, a retention and conversion system that offers an incentive to its members to motivate the members to participate in their membership and maintain their membership, wherein the opportunity for achieving the incentive is related to particulars of the membership.

### BACKGROUND OF THE INVENTION

The commercialization of the use of wide area networks, such as, the Internet or the World Wide Web (“WWW”) has created an entirely new marketplace for businesses. Indeed, since the advent of the Internet, literally hundreds of thousands of businesses have become available on wide area networks and similar numbers of new businesses have been created.

In addition to the creation of the new marketplace, the use of wide area networks has also inspired new models for business practices. Many of the new businesses operating on the Internet are membership based, including, both free memberships and paid memberships. Membership based businesses depend, of course, on conversion of consumers to members and the retention of those members. Depending upon the type of business, many businesses experience the loss of a membership in as little as three months. This creates a constant requirement to advertise and solicit new members or to create an incentive for a former member to return.

To increase conversion rates, some businesses offer incentives with the basic purchase of the membership. However, this type of incentive rarely increases retention rates as consumers merely avail themselves of the incentive offer and then allow the membership to lapse. Further still, many businesses also offer trial periods. Similar to the incentive offer, many consumers participate in the trial period and then merely cancel the membership. Although the foregoing attempts have, in part, assisted in increasing the conversion rate for a business, these solutions have had no effect on retention of the member. Thus, these solutions have limited benefit as they fail to resolve the ongoing problem of stabilizing the membership base.

Further still, participation in an on-line membership requires the initiation and motivation of the member. Indeed, in general, no activities coordinator, or host contacts the members to alert them to additions to the products or services offered by the membership. Although an electronic notice can be forwarded to members regarding these items, no live person contacts the members. Thus, members must be motivated to actively access their membership to participate in any new offerings, or review new products or services. Active participation in the membership increases the likelihood that a member will maintain the membership. A need in the industry exists for a system and method for increasing conversion rates and retention rates for membership based businesses. Further, a need exists for motivating members to actively participate in their membership, wherein the member becomes aware of, and participates in, new products or services.

### SUMMARY OF THE DISCLOSURE

Embodiments of the invention are directed to retention and conversion system for retaining existing members of a membership based organization or business and encouraging new members to join the membership based organization. Embodiments of the conversion and retention system operate on a network system having a provider server and a user computer, wherein the provider server and the user computer are in electronic communication via a communication link. In general, the conversion and retention system operates in conjunction with a particular business, organization or association that is accessible to users via a web page or a series of web pages on the network.

In preferred embodiments, the conversion and retention system comprises an incentive or rewards program having an identifiable incentive or reward, a membership database, an opportunity schedule and a selection means. The incentive program is a raffle or lottery or any other type of suitable program capable of providing or offering a reward, such as money, a product, or a service, used to motivate user behavior or decisions. In some preferred embodiments, the incentive is displayed in association with the business or organization, such as, on a web site or advertisement for the web site, to encourage users to become a member of the web site, and to encourage members to maintain and participate in their membership.

Each incentive program is open for entry for a predefined time period per identified incentive. To participate in the incentive program, a user must be a member of the membership based business, such as, for example, by retaining a membership in the web site affiliated with the business. In preferred embodiments, the extent of the opportunity to obtain the identified incentive, for example, the number of entry opportunities for the raffle, is related to the type of membership of the individual member.

Upon retaining a membership, or signing up with the web site, a user name or user identification is associated with the user. Additionally, the user selects a password for entry into the web site. The user identification, password and type of membership is stored in the membership database, which is coupled to the provider computer.

The system further comprises an opportunity schedule, wherein the opportunity schedule lists the type of membership and the associated opportunity to obtain the incentive, that is, the number of entries for each raffle each membership type is eligible to receive per incentive program. In preferred embodiments, the opportunity schedule includes scaled or weighted opportunities, wherein the opportunities are weighted in accordance with predefined factors, including, but not limited to, the term of membership and the type of membership.

At the commencement of an incentive program, such as a raffle, all members are entered into the raffle in accordance with the opportunity schedule. Members can be entered via any suitable means, including, but not limited to, the submission of their user identification, the submission of a virtual token or ticket having an identifier, such as a number or alpha numeric character, or symbol, wherein the token identifier is associated with the user identification, or any other suitable means of associating a user identification with an entry character or symbol.

Upon the expiration of the entry period, the system randomly selects the winning entry via the selection means. In one preferred embodiment, the selection means is an algorithm that randomly generates a user identification, a portion of a user identification, a character, a number, or a symbol, although any other means capable of selecting an entry from the pool of entrants is suitable.

The winning entry is associated with a particular member identification and represents the winner of the raffle. The member possessing the winning entry is announced as the winner of the raffle, and the identification of the winner is displayed in a restricted area on the web site. The identification of the winner is displayed for a preset period of time, wherein the winner must claim the prize within the preset period of time. As the identity of the winner is not located in a freely accessible area of the web site, to ascertain the identity of the winner, a member must enter the restricted area within the preset period of time via a password or other suitable means. Upon the expiration of the preset period of time, if the winner fails to claim the prize, the winner's name is removed, and a new raffle winner is identified via the selection means.

A feature of embodiments of the present invention is that the winner of the raffle or incentive program is displayed in a member restricted area for a predefined period of time. An advantage to this feature is that the members have an incentive to frequently enter the web site thereby, increasing participation in the membership and the member's exposure to new goods or services.

A further feature of embodiments of the present invention is that the number of entry opportunities to the raffle is related to the type and length of membership maintained by the user. An advantage to this feature is that users have an incentive to upgrade their memberships and maintain their memberships for longer periods of time. A further advantage to this feature is that the membership retention rate increases for the web site, thereby stabilizing the membership base.

A still further feature of embodiments of the present invention is that non-paying users with limited memberships can participate in the incentive program. An advantage to this feature is that all users have an incentive to obtain a membership, maintain their membership and to participate in the web site on a daily basis. Another advantage to this feature is that the conversion rate for non-paying members to paying memberships increases as members become more familiar with the web site and the goods and services offered by the business affiliated with the web site.

A feature of embodiments of the present invention is that the incentive is displayed on the web site in a manner that all users, including non-members, can view. An advantage to this feature is that non-members can be attracted to join the web site, thereby increasing the conversion rate for the web site.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the instant invention.

FIG. 2 depicts a block diagram of the conversion and retention system in accordance with a preferred embodiment of the invention.

FIG. 3 depicts a representative example of an opportunity schedule in accordance with the embodiment of FIG. 2.

FIG. 4 depicts a block diagram of the operation of the retention and conversion system in accordance with a preferred embodiment of the invention.

### DETAILED DESCRIPTION OF THE PREFERRED EMBODIMENTS

Preferred embodiments of the instant invention operate on a network, such as, for example, the Internet or World Wide Web (“WWW”), or any other type of network system, including, an internet or an intranet.

Hardware Environment:

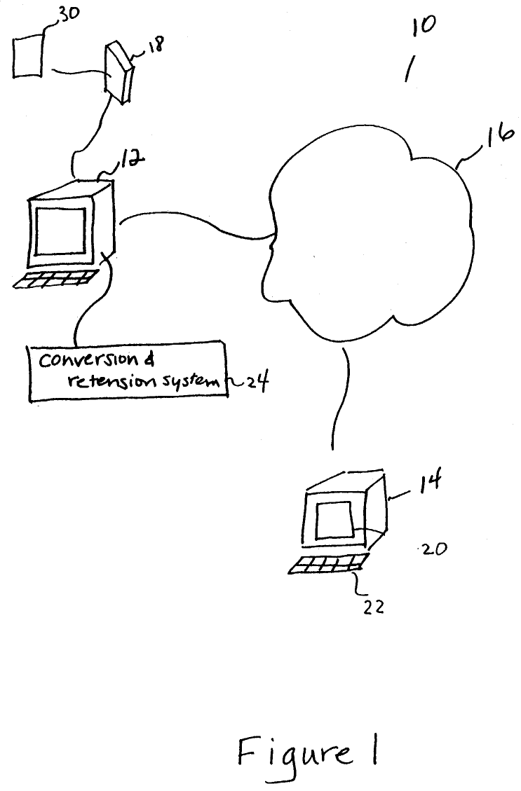

Preferred embodiments of the instant invention operate in accordance with a plurality of networked computers, such as, for example, a user computer and a provider computer which are coupled together on a communications network, such as, for example, the Internet or a wide area network. FIG. 1 depicts a network system 10 that operates in accordance with preferred embodiments of the invention. In preferred embodiments, the network system 10 includes a server computer 12, or a provider computer, and a user computer 14, wherein the provider computer 12 and the user computer 14 are in electronic communication with each other via a communication link 16.

In some preferred embodiments, the network system 10 includes a plurality of either the provider computer 12, the user computer 14 or any combination thereof. The provider computer 12 contains information regarding businesses, programs, associations or organizations offering goods and services, and other relevant data that is accessible by the user computer 14.

The provider computer 12, or server, may comprise any suitable network device capable of providing content (data representing text, hypertext, photographs, graphics video and/or audio) for communication over the network. In preferred embodiments, the provider computer 12 comprises a programmable processor capable of operating in accordance with programs stored on one or more computer readable media (for example, but not limited to, floppy disks, hard disks, random access memory RAM, CD-ROM), to provide content for communication to the user computer 14. The provider computer 12 may comprise, for example, but is not limited to, a personal computer, a mainframe computer, network computer, portable computer, personal digital assistant (such as, a 3Com Palm Pilot), or the like. The provider computer 12 may include one or more internal data storage devices (not shown) for storing content for communication to a user computer 14. Alternatively, or in addition, the provider computer 12 may be coupled to an external data storage device, computer or other means, generally represented at 18, from which the provider computer 12 may obtain content for communication to the user computer 14.

In a preferred wide area network environment, such as the Internet environment, the provider computer 12 is controlled by suitable software to respond to a valid request for content by providing (or downloading) data in the form of, for example, one or more HTML files to the user computer 14 from which the request was made. It will be understood by those skilled in the art that this process involves communications through suitable servers, routers and other components, as is dictated by the particular network environment.

Each provider computer 12 operates with a persistent storage means (not shown), for example, one or more of the fixed and/or removable data storage devices and/or data communications devices connected to the computer. The communication link 16 may include a public network, such as the Internet, a local area network, or any other suitable communications connection, hardwired, wireless, or a hybrid thereof.

The user computer 14 may comprise any suitable network device capable of communicating with other network devices in the network system. In preferred embodiments, each user computer comprises a programmable processor capable of operating in accordance with programs stored on one or more computer readable media (for example, but not limited to floppy disc, hard disc, computer network, random access memory (RAM), CD Rom, or the like), a display device 20 for providing a user-perceivable display (for example, but not limited to visual displays, such as cathode ray tube CRT displays, light-emitting-diode LED or liquid crystal-diode LCD displays, plasma displays or the like, audio displays or tactile displays), and a user input device 22 (for example, but not limited to, a keyboard, mouse, microphone, or the like). In one preferred embodiment, at least one user computer comprises a personal computer system having a CRT display, a keyboard and a mouse user-input device.

The user computer 14 is controlled by suitable software, including network communication and browser software to allow a user to request, receive and display information (or content) from or through a provider computer 12 on the network system 10. The user computer 14 operates in accordance with programs stored on a readable medium, including, but not limited to, floppy disks, hard disks, RAM and CD-ROM. The user computer 14 is any means capable of communicating with the provider computer 12, including, but not limited, to personal computers, kiosks and ATM-type machines. The user computer 14 accesses the provider computer 12 via the wide area network or through some other remote access, such as, for example, by telephone, facsimile, personal digital assistant, web TV, or any other device or method that communicates alpha numeric data with a server.

General Description of Preferred Embodiments:

Embodiments of the present invention are directed to a system and method for membership conversion and retention. In particular, embodiments of the present invention comprise an identifiable incentive for members to participate in their membership, wherein the opportunity to receive the identified incentive is related in part, to the type of membership of the individual member, and thus, can vary from member to member.

With reference again to FIG. 1, embodiments of the conversion and retention system operate on the network system 10, wherein the conversion and retention system 24 is coupled to, and controlled by the provider computer 12. In general, the conversion and retention system operates in conjunction with a particular business, program, association or organization, such as, an investment club that offers investing advice, a photographic library that allows downloading and reviewing of various types of images, a music club that offers the sale, exchange and review of music, or any type, or combination, of services or products. The provider server 12 provides the user computer 14 access to the business utilizing the conversion and retention system via an interface, such as a series of web pages, wherein the series of web pages represent a web site that is directed to, and contains information about the particular business.

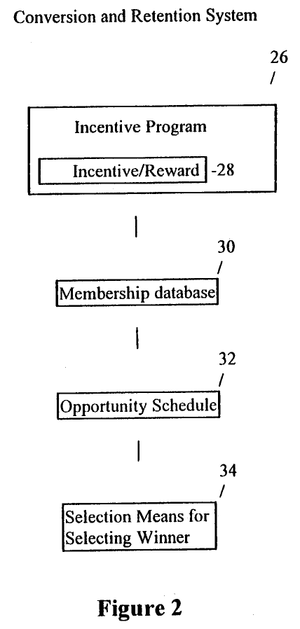

With reference to FIG. 2, the conversion and retention system 24 comprises an incentive or rewards program 26 having an identifiable incentive or reward 28, a membership database 30, an opportunity schedule 32 and a selection means 34. The incentive program is a raffle or lottery or any other type of suitable program capable of providing a reward, such as money, a product, or a service, to motivate user behavior or decisions. To attract users to a particular business, the identifiable incentive 28 is displayed on a web page associated with the business, wherein the incentive encourages users to join a membership, free or paid, and encourages members to maintain and participate in their membership. In particular, the incentive program, via the provider computer 12, identifies an incentive for members and non-members via an announcement or advertisement on a web page, such as, the home page of the web site for the particular business, or a third party web site via an advertisement. In this regard, all users, whether non-members or members, become aware of the availability of the incentive.

The incentive can be money, a product or a service, or any combination thereof. In one preferred embodiment, the incentive is a predefined amount of money, for example, $100.00. The incentive is offered as a prize, wherein to be eligible to receive the incentive, or prize, the user must become a member of the web site. In some preferred embodiments, the incentive or prize is increased by a set amount if the prize is not claimed. In one preferred embodiment, $100.00 is offered as a prize per day, wherein if the previous day's prize was not claimed, an additional $100.00 is added to the previous unclaimed amount. Thus, in some instances, the prize amount can become quite substantial.

The membership database 30 is a database containing the user information and is stored on the storage database 18. The user information is input via the user computer 14 and is any type of pertinent information about the user, including, but not limited to, the user's address, the user's electronic address, a password and a user identification. In preferred embodiments, the user identification is selected by the system, however, in some embodiments, the user identification is selected by the user. In all instances, the password is selected by the user. The user information is stored in association with the type of membership maintained by the user, including the term of the membership. If a membership is changed, for example, the membership is upgraded, the new type of membership will be recorded in the membership database 30.

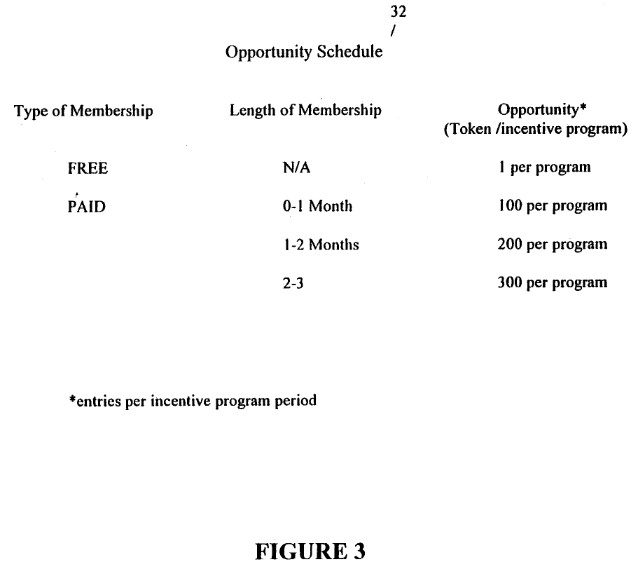

With reference to FIG. 3, the opportunity schedule 32 is a listing or schedule of the types of memberships offered by the web site and the associated opportunity, or number of chances, that each type of membership is eligible to receive for each incentive program. The opportunity schedule 32 is made available to the users on the web site so as to allow the user to assess the correlation between the number of entries into the incentive program and the selected membership. Thus, if a member chooses to increase the opportunity to win the reward, the member will change the type of membership maintained, or maintain the current membership for a longer period of time, or a combination of these activities.

The selection means 34 is a computer program or random generator that randomly selects and identifies, from the pool of entrants, the winner of the incentive program. In some preferred embodiments, the selection means is a algorithm that randomly generates a combination of characters, numbers, symbols and the like, wherein the random combination is configured to match a user identification, a portion of a user identification, a character, a number or symbol, that has been entered into the raffle. It is to be understood that any other means capable of generating a random set of characters from the total set of characters entered into the incentive program is suitable. Once the selection means 34 generates the random combination of characters, numbers or the like, the random combination is matched to one of the entries in the incentive program.

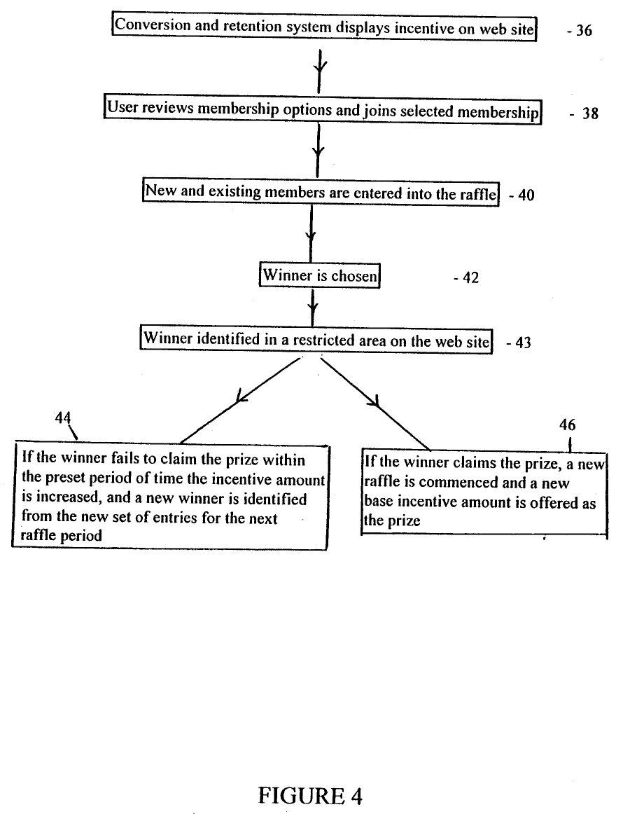

With reference to FIG. 4, to commence a new incentive program, the conversion and retention program establishes the base incentive, for example, $100.00. Once the incentive is established, it is displayed on a web page, or in an advertisement associated with the web site of the business such that members and non-members of the web site can view the incentive 36. Once the incentive has been displayed, the current incentive program is open for entries.

As stated above, to participate in the raffle, a user must enroll as a member of the affiliated business or program. In preferred embodiments, the business or program offers a variety of memberships, including, but not limited to, free memberships, a trial membership or various membership packages. It is to be understood that restrictions may be placed on the various types of memberships, and thus, not all memberships reflect equal access to the web site. For instance, in some embodiments, a free membership is offered for electronic mail and an electronic magazine that is available on a daily basis. To access and set up an electronic mail account, or to receive the magazine, a user must sign up as a subscriber, although no fee for subscription is required.

Upon review of the various options for membership, the user selects the type of membership which is suitable 38 for the needs or desires of the user. To enroll as a member, the user accesses the web site of the program via the user computer 14 and registers or enrolls with the program via a sign up page, wherein the sign up page was transmitted to the user computer 14 via the provider computer 12. The sign up page includes a ‘Sign Up’ button, or any other interface that may be suitable. Upon depression of the ‘Sign Up’ button, the sign up page is transmitted to the user, wherein the user inputs identifying information, including, but not limited to, an account name, a unique identification and a password. The information is input via input boxes or via response to questions presented by the provider server 12. Once the user is satisfied that the input information is accurate, the participant submits the information to the system via a ‘Submit’ button. The submitted information is then transmitted to the membership database 30 which is stored in the storage device 18. It is to be understood that the memberships offered by the businesses do not represent the exclusive access to the web site, but rather, offers the member access to information that may not otherwise be available, even if the membership is free. For instance, an investment style web site may offer users the ability to track their investments. However, to access the software enabling the tracking of the investments requires the user to join the investment site as a member. In joining the free membership, the user agrees to abide by certain conditions, and thereby, relieves the web site owner of certain liabilities.

As discussed above, in preferred embodiments, the opportunity to obtain the identified incentive is related to the type of membership of the individual member, that is, to the number of entries for each raffle each membership type is eligible to receive per incentive program. In one preferred embodiment, the number of tickets is equivalent to the number of times a user's identification is placed in the raffle.

As the choice of membership dictates, in part, the number of entries of the member in the raffle, users may review the opportunity schedule 32 to assess the opportunity to receive the reward based upon the various types of memberships. Indeed, as some memberships are more valuable, for example, paying memberships, the paying member may receive more opportunities, or chances, to win the reward being offered than a member who maintains a free membership. For instance, with reference to FIG. 3, in one preferred embodiment, a free membership of any type provides the opportunity of one entry ticket per day to the raffle. Further, paid memberships can be offered a weighted or scaled entry schedule such that users who have greater participation receive more opportunity for reward. For instance, upon joining, a user may receive 100 tickets per day for the first month, and receive a multiple of this amount for each subsequent consecutive months that the user is a member of the web site. Thus, for example, a user who is a member for three months would receive 100 entries each day for the first month, 200 entries each day for the second month and 300 entries each day for the third month. As this only represents additional entries of the member's identification to the raffle pool, there is no additional cost to the provider server 12. However, the scaled schedule of entry opportunities provides an incentive for the user to remain a member for longer periods of time, thereby increasing the retention rate for the web site.

At the commencement of a raffle period, all members, both new and existing, are entered into the raffle in accordance with the opportunity schedule 40. Members are not required to initiate the entry into the raffle, but rather, are automatically entered. The period for entry into the raffle remains open for a limited time, such that any user joining a membership with the open time frame can be automatically entered into the raffle. In particular, in one preferred embodiment, all of the paid and non-paying subscribers are issued virtual raffle tokens every 24 hours, wherein these tokens exist only as data structures on the system's server. The number of tokens each subscriber is issued is determined, in part, upon the weight factor for each subscriber. Upon the issuance of all of the tokens for the current subscribers, or upon the termination of a predefined period of time, the provider server randomly chooses the winning token via the selection means 42. For example, tokens can be distributed from 12 am to 1 am each day, wherein at 1 am, the winner is selected and the raffle is closed. The selected token is then matched with a particular user identification and represents the winner of the raffle. The subscriber possessing the winning token is announced as the winner of the raffle and the identification of the winner is displayed in a restricted area on the web site, wherein the area is accessible only by members 43. The identification of the winner is displayed for a preset period of time, wherein the winner must claim the prize within the preset period of time. Thus, in the above example, the winner would be displayed for 23 hours, that is, until the next scheduled raffle at 12 am. Upon the expiration of the preset period of time, if the winner fails to claim the prize, the winner's name is removed, and a new raffle winner is identified via the selection means 44. In some preferred embodiments, the pool of entrants is updated so that every member has an increased possibility of winning, or a new raffle is commenced.

As the identity of the winner is not located in a freely accessible area of the web site, to ascertain the identity of the winner, a member must enter the restricted area within the preset period of time. Since the web site offers a variety of memberships, the restricted area pertaining to each type of membership may differ. Thus, the members must enter the restricted area specific to their membership. In preferred embodiments, to enter the restricted area the user must enter the password provided by the user to the system at registration. As discussed above, if the winner of the raffle fails to claim the prize within a predefined amount of time, for example, a 23 hour period from posting, the incentive amount is increased and a new winner is identified from the new set of entries for the next raffle period. It is to be understood that it is not required to increase the incentive if the prize is unclaimed. If the winner does claim the prize, a base incentive amount is placed in the raffle 46, for example, $100, and a new raffle is commenced, wherein a new winner is chosen at a preset time, for example, midnight.

In other preferred embodiments, the owners of other web sites, that is, web masters, that are affiliates, or partners, with the provider server 12 can also participate in the system. In these embodiments, if the web master signs up the winning participant, the web master may also be declared a winner in conjunction with the member. Thus, web masters will be encouraged to sign up many new members as it increases their changes of winning a raffle. In these instances, the provider server 12 provides a separate prize for the web master, or the web master and winner share the prize. This shared prize possibility could be limited to the first raffle in which the user participates, or could continue indefinitely. To ascertain the identity of the winner, similar to the member, the web master would be required to enter a restricted area of the web site on the provider server 12, thereby, encouraging the web masters to further participate in the web site.

Although the foregoing described the invention with preferred embodiments, this is not intended to limit the invention. Indeed, it is to be understood that embodiments of the invention can be incorporated into any type of business or service, including, off-line businesses desiring to increase membership or retain existing members. For example, a brick and mortar bookstore could utilize this system by requiring users to visit the store once a week to ascertain the identity of the winner. In this regard, visiting members of the store's membership could shop for desired goods, namely, books, on a more frequent basis. Further, a limited, or special membership can be offered for a minimum purchase amount, or the occurrence of another predefined event. Thus, if a user spends a minimum amount of money within a time frame prior to the raffle, the user is automatically entered into the next raffle and is given a temporary password to access the restricted area to ascertain whether the user has won. In this regard, users can be encouraged to spend money at the business or program even if they do not desire to maintain a membership. In addition to the above described embodiments, the foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

What is claimed is:

1. A membership retention and conversion method for maintaining preexisting members in a membership based program and recruiting non-members to join the program, wherein the membership based program offers at least one type of membership and is capable of recording the term of the membership, comprising:
offering an incentive program, wherein the incentive program is associated with the membership based program and wherein the incentive program includes a predefined reward;
displaying the predefined reward, wherein the reward can be viewed by members and non-members;
displaying an opportunity schedule, wherein the opportunity schedule defines the number of entries a type of membership is eligible to receive;
entering members into the incentive program in accordance with the opportunity schedule;
selecting a winning entry;
displaying, for a predefined time period, the winning entry in a restricted area of the membership based program, wherein members can access the restricted area; and
transferring the reward to the member having the winning entry upon the receipt of a claim of interest in the reward by the member possessing the winning entry; or
if no member claims the reward, selecting a new winning entry.

2. A membership retention and conversion method as claimed in claim 1, wherein the opportunity to acquire the incentive is dependent upon any of the following: the length of time a user is a member or the type of membership.

3. A membership retention and conversion method as claimed in claim 1, wherein members are entered automatically at a predefined time.

4. A system for maintaining preexisting members in a membership based program and recruiting non-members to join the program, having a provider computer and at least one user computer, wherein the provider computer and the user computer are in communication therebetween, and wherein the membership based program offers at least one type of membership and is capable of recording the term of the membership, comprising:
an incentive program, wherein the incentive program includes a predefined reward and a predefined time period for the display of the reward;
a display means accessible to members and non-members for displaying the predefined reward;
an opportunity schedule, wherein the opportunity schedule defines the relationship between the types of memberships and the number of entries each type of membership is eligible to receive;
a entry means for entering members into the incentive program in accordance with the opportunity schedule;
a selection means for selecting a winning entry;
a restricted portion of the program, wherein the restricted portion is accessible to members and is configured to display the winning entry;
a means to receive a claim of interest in the reward by the member possessing the winning entry; and
a timer, wherein the timer determines whether the predefined time period for displaying the reward has elapsed.

5. A membership retention and conversion system as claimed in claim 4, wherein the opportunity to acquire the incentive is dependent upon any of the following: the length of time a user is a member or the type of membership.

6. A membership retention and conversion system as claimed in claim 4, wherein members are entered automatically at a predefined time.

7. A membership retention and conversion method for rewarding a first user for referring a second user to a membership based program, wherein the membership based program offers at least one type of membership and is capable of recording the term of the membership, and wherein the second user joins a membership, comprising:
assigning a referring identification to the first user;
identifying a second user as being referred by the first user, wherein the second user joins a membership;
associating the referring identification with the second user;
storing the referring identification in a storage database and storing the second user identification in association with the referring identification in the storage database;
offering an incentive program, wherein the incentive program is associated with the membership based program and wherein the incentive program includes a predefined reward;
displaying the predefined reward, wherein the reward can be viewed by the first user and the second user;
displaying an opportunity schedule, wherein the opportunity schedule defines the number of entries a type of membership is eligible to receive;
entering the first user and the second user into the incentive program in accordance with the opportunity schedule, wherein the first user receives the same number of entries as the second user;
selecting a winning entry;
displaying, for a predefined time period, the winning entry in a restricted area of the membership based program, wherein the first user and second user can access the restricted area; and
transferring at least a portion of the reward to the first user if the second user has the winning entry and the first user or the second user identifies the first user as possessing the winning entry.

8. A membership retention and conversion method as claimed in claim 7, wherein the opportunity to acquire the incentive is dependent upon any of the following: the length of time a user is a member or the type of membership.

9. A membership retention and conversion system as claimed in claim 7, wherein the first user and the second user are entered automatically at a predefined time.
